(19) United States
(12) Patent Application Publication
(10) Pub. No.: US 2006/0050140 A1
(43) Pub. Date: Mar. 9, 2006

(54) Wireless communication terminal and its method for generating moving picture using still image

(76) Inventors: Jae-Gyoung Shin, Seoul (KR); Hak-Hwa Kang, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/147,911

(22) Filed: Jun. 7, 2005

(30) Foreign Application Priority Data
Sep. 8, 2004 (KR) 10-2004-0071855

(51) Int. Cl. H04N 7/14

(52) U.S. Cl. 348/14.02; 348/14.01

(57) ABSTRACT

A wireless communication terminal and its method for producing a moving picture by using still images are disclosed. The wireless communication terminal includes: a controller for controlling the wireless communication terminal; a camera module for obtaining still image; a storage for storing the obtained still image and a moving picture generated by using the obtained still image; an input unit for receiving a menu selection signal including an editing request signal and a still image selection signal; a generator for generating a moving picture according to the editing request signal by selecting a plurality of still images, reading the selected still images from the storage and using the read still images, storing the generated moving picture, and reproducing the stored moving picture; and a displayer for outputting the reproduced moving picture.

### FIELD OF THE INVENTION

The present invention relates to a wireless communication terminal and its method for producing a moving picture by using still images; and, more particularly, to a wireless communication terminal and its method for producing a multimedia moving picture by generating a moving picture by editing a plurality of still images and additional mixing a background music to the generated moving picture.

### DESCRIPTION OF RELATED ARTS

A wireless communication terminal is a portable terminal for a wireless communication such as a mobile communication terminal, a personal communication service (PCS) terminal, a personal data assistance (PDA) terminal, a smart phone, a IMT-2000 terminal which is a next generation terminal capable of handling data based on international mobile telecommunication (IMT)-2000 and a wireless local area network terminal.

A main issue for developing the wireless communication terminal in early years is miniaturization and light weighted. However, users of the wireless communication terminal further demands a wireless communication terminal having various functions recently. For example, the user demands a wireless communication terminal having functions of receiving wireless internet service or television broadcasting data, digital camera/camcorder, playing games, MP3 player and a compass.

Among the wireless communication terminal having additional functions, the wireless communication terminal having a digital camera function, commonly called as a digital camera phone, has been popular since its convenience. That is, the user can easily take a picture and transfer the picture to a target person by using the digital camera phone. According to development of the digital camera technology, a quality of photos took by the digital camera phone has been closed to a quality of a photo took by a digital camera. Therefore, it is expected that the digital camera function is one of necessary functions to be included in the wireless communication terminal.

However, the wireless communication having the digital camera function requires a decoder and an encoder for compressing data and reproducing the compressed data because a digital image signal acquired by the digital camera function includes a lot of data. Generally, a transform coding using a discrete cosine transform (DCT) is used for eliminating a redundancy as a digital image compressing technique in case of still image. In case of moving picture, a predictive coding using motion compensation between variations of objects in the moving picture is used with the DCT.

In a meantime, the digital camera phone takes a still image or takes moving pictures by using MPEG-4 encoding according to a selection of menu provided from the digital camera phone. However, the conventional digital camera phone does not provide a function for producing a moving picture by using still images. For producing the moving picture, the still images have to be downloaded from the conventional digital camera phone to a personal computer and the downloaded still images are edited in the personal computer. The above mentioned procedure for producing the moving picture by using the digital camera phone is annoying process.

### SUMMARY OF THE INVENTION

It is, therefore, an object of the present invention to provide a wireless communication terminal and it's method for producing a moving picture by using a plurality of still images selected by a user.

It is another object of the present invention to provide a wireless communication terminal and it's method for producing a multimedia moving picture by producing a moving picture by using a plurality of still images and adding background music into the produced moving picture.

In accordance with an aspect of the present invention, there is provided a wireless communication terminal for producing a moving picture by using a plurality of still images, the wireless communication terminal including: a controller for controlling the wireless communication terminal; a camera module for obtaining still image according to a control of the controller; a storage for storing the obtained still image according to a control of the controller and storing a moving picture generated by using the obtained still image; an input unit for receiving a menu selection signal including an editing request signal and a still image selection signal; a generator for generating a moving picture according to the editing request signal by selecting a plurality of still images according to the still image selection signal from the input unit, reading the selected still images from the storage and using the read still images, storing the generated moving picture, and reproducing the stored moving picture; and a displaying unit for outputting the reproduced moving picture according to a control of the controller.

In accordance with another aspect of the present invention, there is also provided a wireless communication terminal for producing a moving picture by using a plurality of still images, the wireless communication terminal comprising: a controller for controlling the wireless communication terminal; a camera module for obtaining still image according to a control of the controller; a storage for storing the obtained still image according to a control of the controller and storing a moving picture generated by using the obtained still image; an input unit for receiving a menu selection signal including an editing request signal and a still image selection signal; and a displaying unit for outputting the reproduced moving picture according to a control of the controller.

In accordance with still another aspect of the present invention, there is also provided a method for producing a moving picture by using still images, the method comprising the steps of: a) selecting a plurality of still image for producing the moving picture; b) generating a moving picture file according to a predetermined moving picture format by using the selected still images; and c) storing the generated moving picture file.

### BRIEF DESCRIPTION OF THE DRAWINGS

The above and other objects and features of the present invention will become apparent from the following description of the preferred embodiments given in conjunction with the accompanying drawings, in which:

FIG. 1 is a diagram illustrating a wireless communication terminal having a function for producing moving picture by using still images in accordance with a preferred embodiment of the present invention;

FIG. 2 is a detailed diagram illustrating a moving picture generating unit 20 in FIG. 1;

FIG. 3 is a flowchart showing a method for producing a moving picture by using still images in a wireless communication terminal in accordance with a preferred embodiment of the present invention;

FIG. 4 is a diagram showing user interfaces for explaining a procedure of selecting still images in accordance with a preferred embodiment of the present invention;

FIG. 6 is a diagram showing user interfaces for explaining a procedure of processing still images to have a predetermined effect in accordance with a preferred embodiment of the present invention;

FIG. 7 is a diagram showing user interfaces for explaining a procedure of storing and reproducing a moving picture in accordance with a preferred embodiment of the present invention; and

FIG. 8 is a diagram showing a wireless communication terminal for producing a moving picture by using still images in accordance with another preferred embodiment of the present invention.

### DETAILED DESCRIPTION OF THE INVENTION

Other objects and aspects of the invention will become apparent from the following description of the embodiments with reference to the accompanying drawings, which is set forth hereinafter.

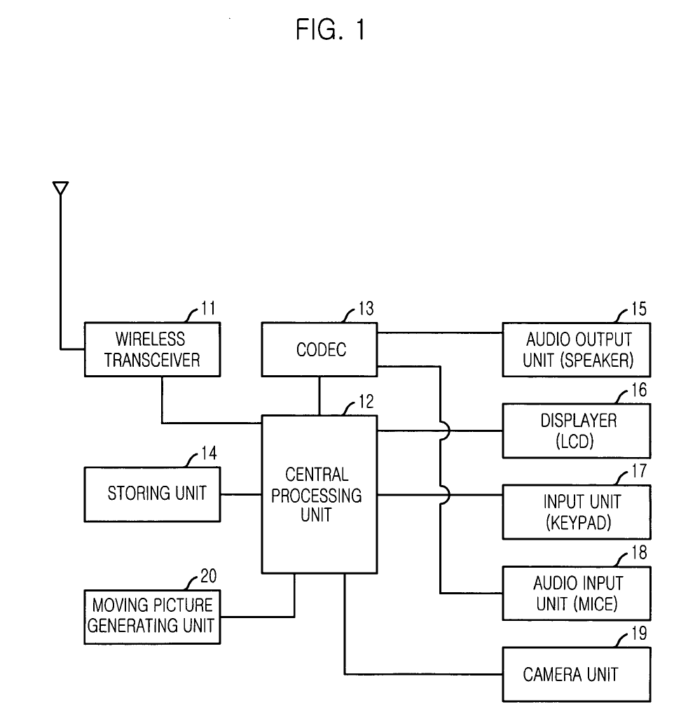

FIG. 1 is a diagram illustrating a wireless communication terminal having a function for producing moving picture by using still images in accordance with a preferred embodiment of the present invention.

As shown in FIG. 1, the wireless communication terminal includes a wireless transceiver 11, a central processing unit 12, a codec 13, a storing unit 14, an audio output unit (speaker) 15, a displayer (LCD) 16, an input unit (keypad) 17, an audio input unit (mice) 18, a camera unit 19 and a moving picture generating unit 20.

The wireless transceiver 11 transmits and receives a signal through wireless link by using an antenna (not shown).

The central processing unit (CPU) 12 drives and controls the wireless communication terminal.

The moving picture generating unit 20 reads a plurality of still images selected among still images stored in the storing unit 14 according to a moving picture producing signal inputted from the input unit 17 and produces the moving picture by using the read still images. During producing the moving picture, the moving picture generating unit 20 additional inserts a text, a caption and a background music.

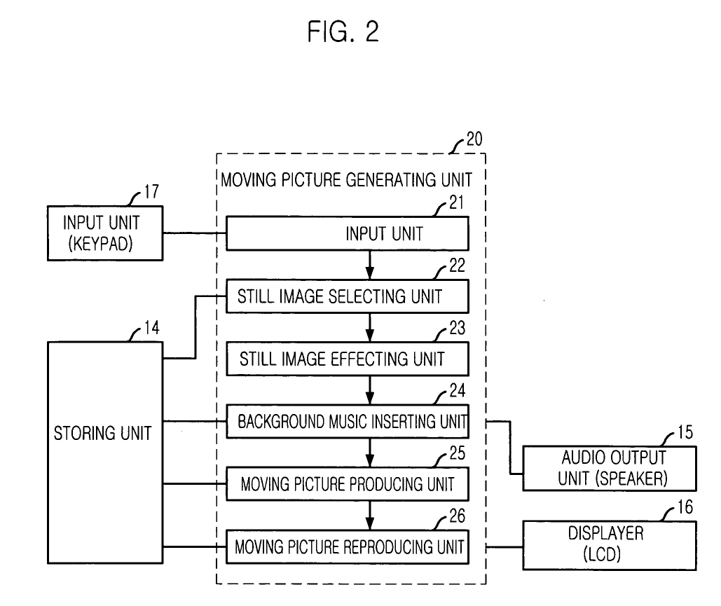

That is, the moving picture generating unit 20 arranges the selected still images according to a predetermined order, generates a slide show by processing the still images to have various effects and inserting caption files, texts and music files and encodes the generated slide show based on MPEG-4. Functions of the moving picture generating unit 20 will be explained in later with referring to FIG. 2.

The codec 13 converts signals transferred from the wireless transceiver 11 according to control of the CPU 12 and outputs the converted signal to the audio output device 15. The codec 13 also converts audio data inputted from the audio input unit 18 to an audio signal and transfers the audio signal to the CPU and the audio signal is outputted through the wireless transceiver 11.

The storing unit 14 stores programs for driving the wireless communication terminal such as a code and a firmware. Specially, the storing unit 14 stores still images took by using the camera unit 19 and a moving picture generated by using the took still images.

The audio output unit 15 outputs the audio data transferred from the codec 13 and the audio input unit 18 transfers audio data inputted from a user to the codec 13.

The displayer (LCD) 16 provides a user interface to a user according to control of the CPU 12. The displayer 16 also displays a user interface for selecting still images and displays the moving picture produced by using the selected still images.

The input unit 17 receives inputs from a user, where the inputs includes telephone numbers and a menu selection signal including a photographing request signal, a editing request signal, a still image selection signal.

The camera unit 19 takes a still image or a moving picture according to control of the CPU.

FIG. 2 is a detailed diagram illustrating a moving picture generating unit 20 in FIG. 1.

As shown, the moving picture generating unit 20 includes an input unit 21, a still image selecting unit 22, a still image effecting unit 23, a background music inserting unit 24, a moving picture producing unit 25 and a moving picture reproducing unit 26.

The input unit 21 receives various menu selection signals including a still image selection signal, an editing request signal, an effect request signal and a background music selection signal.

The still image selection unit 22 reads a plurality of still imaged stored in the storing unit 13 for producing the moving picture according to the still image selection signal transferred from the input unit 21.

The still image effecting unit 23 performs functions of filtering, drawing, inserting texts and stamping to the read still images selected by the still image selection unit 22 according to the still image effect request signal from the input unit 21.

The background music inserting unit 24 reads music source files from the storing unit 14 according to the background music selection signal inputted from the input unit 21.

The moving picture producing unit 25 produces a moving picture file i.e., MPEG-4 type moving picture by combining the plurality of the still images processed in the still image effecting unit 23 with the music source files from the background music inserting unit 24. The produced moving picture is stored in the storing unit 14.

The moving picture reproducing unit 26 reads the generated moving picture stored in the storing unit 14, reproduces the read moving picture, and displays and outputs the reproduced moving picture on the displayer 16 and to the audio output unit 15.

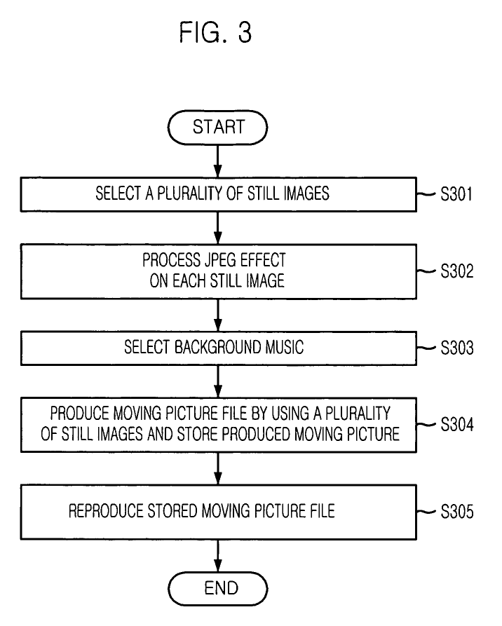

Operation of the present invention is explained in detail with referring to FIG. 3 hereinafter.

FIG. 3 is a flowchart showing a method for producing a moving picture by using still images in a wireless communication terminal in accordance with a preferred embodiment of the present invention.

As shown in FIG. 3, the moving picture generating unit 20 of the wireless communication terminal outputs a user interface on the displayer for selecting still images according to an editing request signal inputted from the input unit 17 and receives selection of the still images from a user at step S301. The request for producing the moving picture may be received from the user by activating a menu key when the user selects a plurality of still images.

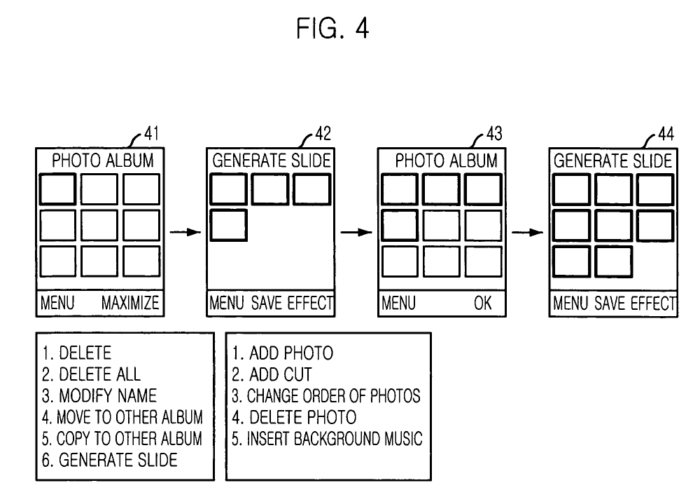

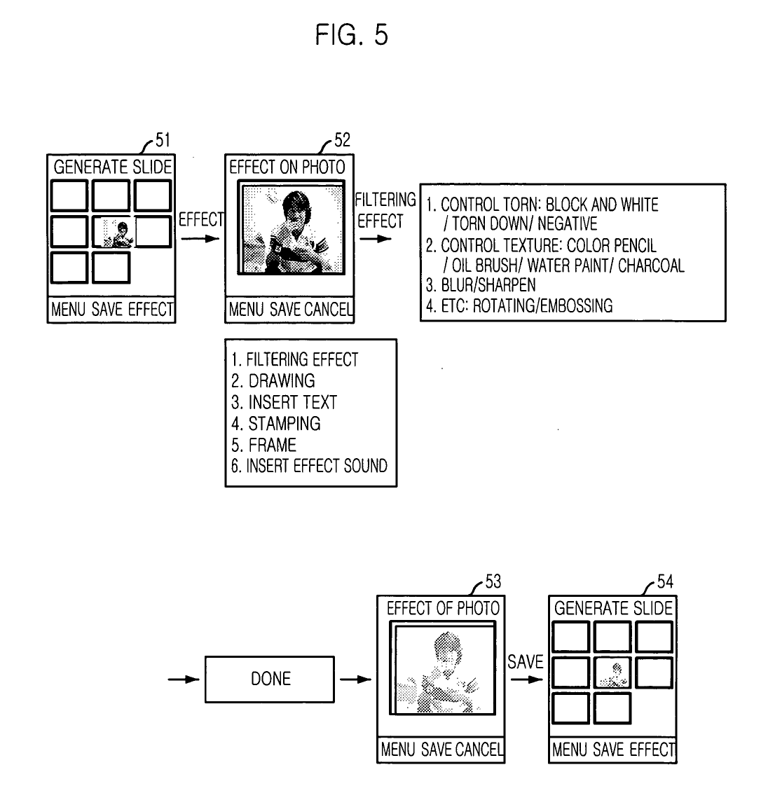

During selecting still images, the still images may be displayed on the displayer by using a thumbnail option as shown in FIG. 4 for viewing a plurality of still images on single frame of image. By displaying a plurality of still images on single frame of image, the user may conveniently select still images among the displayed still images. The thumbnail option is one of viewing options for displaying multiple images on single frame of image. In the thumbnail option, a single frame of image including a plurality of small sized images is displayed on the displayer.

As shown in FIG. 4, if a menu key is selected in a user interface 41, various menus are displayed at the displayer for selecting menus of delete, delete all, modify name, move to other album, copy to other album and generate slide. When the user selects a menu of generate slide, a user interface 42 is displayed. The user interface 42 provides various operations for adding images, adding a cut image for distinguishing scenes, changing order of images, deleting images and inserting a background music by selecting corresponding menu keys. For example, if the user selects a menu key of “add photo” in the user interface 42, a user interface 43 is displayed at the displayer for additionally selecting still image in order to produce the slide (moving picture).

During adding the selected image, the selected still image is added in a location where a cursor is located among arranged still images and one or multiple images may be selected.

After performing the step S301, the moving picture generating unit 20 processes each still image to have special effects according to a menu selection signal received from the input unit 17 at step S302. That is, the still images are processed to give special effect on the still image such as a filtering effect including torn control (block and white, torn down, negative), texture control (color pencil, oil brush, water paint, charcoal), Blur (Gaussian blur, motion blur, smart blur), sharpen (sharpen edge, sharpen more) and rotating photo, a drawing effect, a insertion of text, a stamping, a insertion of frame and a insertion of effect sound. The effect sound is a short tune assigned to each still image. It is distinguished from the background music.

As shown in FIG. 5, multiple still images are displayed at a user interface 51 when the user selects multiple images. In the user interface 51, if the user locates the cursor on a predetermined still image among the displayed multiple still images and selects a menu of “effect” for giving effect on the still image, the predetermined still image is selected and displayed as shown in a user interface 52 in FIG. 5. After displaying the predetermined still image, if the user selects a menu key, a list of menus of various effects is displayed. When the user selects one of menu in the list, a sub menu is displayed and the still image is processed to be effected according to selected menu among the sub menu by the user. After processing the still image to have selected effect, the effected still image is displayed as shown in a user interface 53 in FIG. 5.

In the user interface 53, if the user selects a save key for applying selected effect on the still image, the effected still image is stored and the selected multiple image with the effected still image are displayed as the thumbnail option as shown in a user interface 54 of selection still image in FIG. 5. If the user selects a cancel key for not applying selected effect on the still image, the selected multiple images with the selected still image before processing the selected effect are displayed as the thumbnail option as shown in the user interface 54 in FIG. 5.

In the user interface 54, the user can selects functions for adding still image, adding a cut image for distinguishing scene, changing an arrange order of still images, deleting still images and inserting the background music.

At first, the adding still image function is a function for adding additional still image into the moving picture excepting the selected still images. The adding cut image function is a function for adding an image including a background image with texts provided from the wireless communication terminal. The changing an arrange order function is a function changing the order of arrangement of still images. Also, the deleting still image function is a function for deleting a predetermined still image selected among selected multiple still images for eliminating the predetermined still image from the moving picture. The adding background music function is a function for selecting and adding a music source reproduced during reproducing the moving picture. The selected music source is stored as advanced audio coding (AAC) data, qualcomm code excited linear prediction (QCELP) data and enhanced variable rate coder (EVRC) data according to a MPEG protocol. The stored music source and the selected still images are processed to a multimedia data file (MPEG-4).

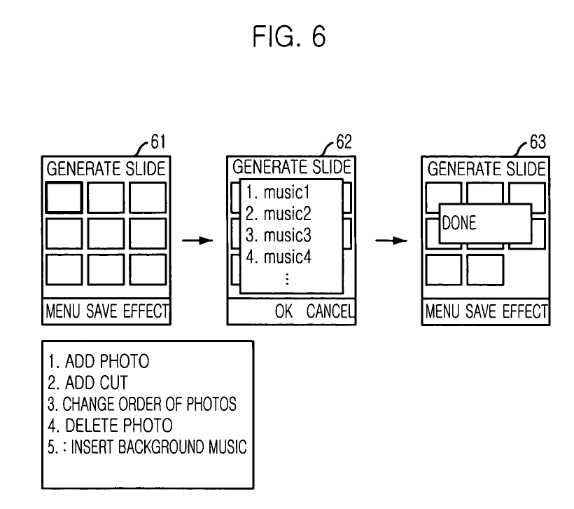

After the step S302, the moving picture generating unit 20 receives a selection of the background music according to a background selection signal inputted from the input unit 17 at step S303. A procedure for receiving the selection of background music is explained by referring to the FIG. 6.

At first, a menu for generating a slide is displayed at the displayer as shown in a user interface 61 of the FIG. 6. In the user interface 61, if the user selects a menu for inserting the background music, a list of music source files are displayed as shown in a user interface 62 in FIG. 6 and the user selects one of music source files in the list. After selecting, a user interface of generating the slide 63 is displayed and a pop-up window is displayed for noticing a result of selecting the background music.

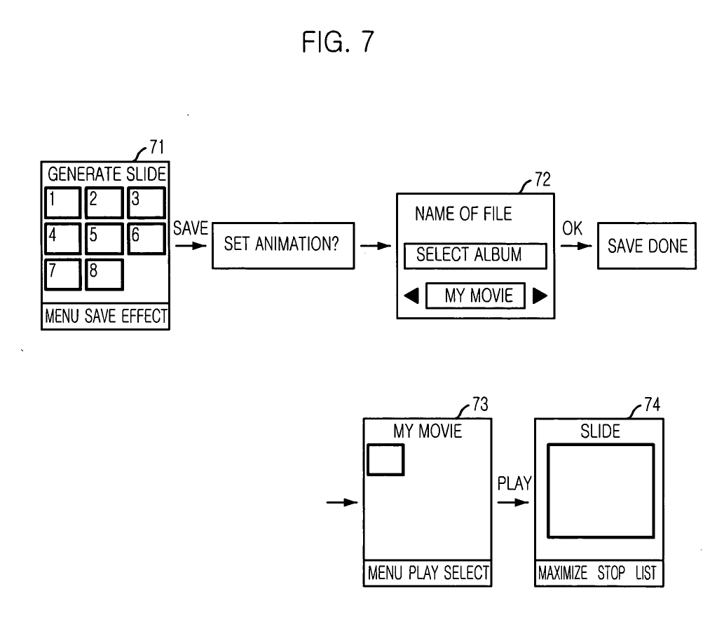

After the step S303, the moving picture generating unit 20 generates a moving picture file by using the effected still images and the selected music source file and then stores the generated moving picture in the storing unit 14 at step S304. The procedure for storing the generated moving picture file is explained by referring to the FIG. 7.

At first, a menu for generating a slide is displayed at the displayer as shown in a user interface 71 of the FIG. 7. In the user interface 71, if the user selects a menu for storing, a user interface 72 for selecting a folder is displayed for storing the generated moving picture file and if the user selects one of folders displayed at the user interface 72, the generated moving picture file is stored in the selected folder i.e., my movie.

After storing, if the user selects one of stored files in a predetermined folder i.e., my movie in a user interface 73 in FIG. 7 and selects a menu for reproducing, a user interface 74 is displayed at the displayer for displaying a moving picture by reproducing the selected file at step S305.

Meanwhile, the moving picture generating unit 20 reproduces the generated moving picture file to the displayer 16 and the audio output unit 15 and then receives the input from the user for storing the generated moving picture file after reproducing.

Also, when the generated moving picture file is stored in the storing unit, the moving picture file is stored as file types such as MPEG-4, skm, 3gp, 3g2, k3g by using the MPEG-4 encoding technique. The file type of skm, 3gp, 3g2, and k3g is a file format for storing the MPEG-4 encoding data. The skm is a file format specified by the SK telecom, the 3gp is a file format specified by the 3^{rd} generation partnership project (3GPP) organization, and the 3g2 is a file format specified by the 3^{rd} generation partnership project 2 (3GPP2) organization. Finally, the K3f is a file format specified by the Korea wireless standardization (KWIS) forum. There is no significant difference among the file formats and each file format has own structure of storing information for the file. The detailed explanation of the MPEG-4 technology is omitted in here because the MPEG-4 technology has been disclosed at various publications and known to skilled in the art.

Hereinafter, a procedure for generating a moving picture by using the MPEG-4 encoding is explained in detail.

At first, the user selects 9 still images and request to editing the moving picture. Moving picture information of 9 still images is combined according to an order of arrangement of the still images and I-frame of each still image is generated.

As a reference, the MPEG-4 is international standard of encoding and compressing digital image and audio data transmitted below transmission speed of 64 kbps. The moving picture experts groups (MPEG) of the joint technical committee 1 (JTC1) progresses standardization of the MPEG-4, where the JTC 1 is a cooperative organization of international standard organization (ISO) and the international engineering consortium (IEC).

The MPEG-4 is a basic compressing method using the DCT and the predictive coding using motion compensation between objects in image frames. That is, all image frames are compressed by not compressing each image frame in the MPEG. The image frames are compressed by using likeness of neighbor frames. (it assumes that there is no significant difference between neighbor frames when the 30 frames are displayed in one second) That is, motion is compensated by using prediction and compensation. Accordingly, the MPEG video file must includes a frame, which can be reproduced by using own information included in the frame, within a regular interval.

The frames are compressed as a still image identically to a joint photographic expert group (JPEG). The I frame is a frame compressed with the still image and a P frame is a frame of prediction. A B frame is a frame of compensation. The MPEG video includes the three frames within a predetermined pattern.

More particularly, the Intra-coded frame (I frame) can be arranged at any places of data stream and used for random access to data. The I frame is coded without referring to other image. The I frame is compressed based on JPEG but it is compressed in real time. The I frame is compressed as the lowest compression rate in the MPEG. The I frame is divided 8*8 blocks assigned within a macro block, the DCT is applied to the divided blocks, the DCT coefficients are encoded based on a differential pulse code modulation method. After computing variation value between consecutive blocks, it is converted by using a variable length coding.

The predictive-coded frame (P frame) is coded and decoded by using information of previous I frame and previous P frame. The P frame is generated by using a fundamental concept that entire image of consecutive image frames is not moved and image blocks of entire image on the frame is moved. That is, all objects on the frame are not moved but one of objects is moved on the next frame. There are no significant differences between two consecutive image frames. Therefore, different value between the objects is used for encoding the P frame.

The bidirectional-coded frame (B frame) is encoded and decoded by using previous and next I frames and P frames. By using the B frame, high compression rate can be achieved. The B frame includes difference values between previous I frame and next I frame, and the previous P frame and the next P frame.

A set of consecutive images of starting with the I frame is a group of picture (GOP). An order of MPEG code data stream may be different with an order of decoding since the B-frame is used. That is, the P frame is previously decoded because the P frame outputted after related B-frame is required for decoding the B frame.

In a meantime, 9 I frames are generated by using the 9 still images and then the MPEG 4 video image is generated by inserting the I frame within a predetermined interval, i.e., 1 second. And then, a background music selected by the user is mixed with the MPEG 4 video image for generating a MPEG 4 video/audio (AV) file. When a time for reproducing the background music is differ from a time for reproducing the MPEG 4 video file, a portion of the background music can be cut or the background music can be repeatedly played.

Also, when the moving picture is constructed with I frame only, a P frame is generated by combining a previous I frame and a next I frame in a predetermined rate i.e., 50% for preventing of discontinuing the moving picture.

In a meantime, when the user controls a time for reproducing each still image, i.e., the user assigns three seconds for reproducing each still image, the I frame is stored triple time within an interval of one second.

Furthermore, the generated moving picture can be registered as a background image and transmitted to other terminal by using a multimedia messaging service (MMS).

Uses of the wireless communication terminal with the camera unit may be maximized by providing the above mentioned functions for producing the moving picture with the still images.

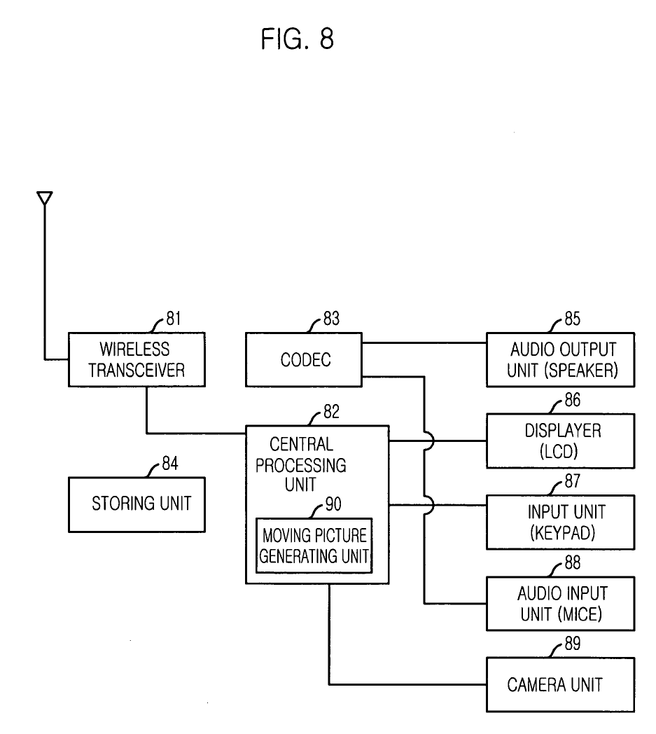

FIG. 8 is a diagram showing a wireless communication terminal for producing a moving picture by using still images in accordance with another preferred embodiment of the present invention.

As shown in FIG. 8, the wireless communication terminal includes a wireless transceiver 81, a central processing unit 82, a codec 83, a storing unit 84, an audio output unit (speaker) 85, a displayer (LCD) 86, an input unit (keypad) 87, an audio input unit (mice) 88 and a camera unit 89.

The wireless transceiver 81 transmits and receives a signal through wireless link by using an antenna (not shown).

The central processing unit (CPU) 82 drives and controls the wireless communication terminal. Furthermore, the CPU 82 includes a moving picture generating unit 20 reading a plurality of still images selected among still images stored in the storing unit 84 according to a moving picture producing signal inputted from the input unit 87 and producing the moving picture by suing the read still images. Detailed explanation of the moving picture generating unit 20 is omitted in here since the moving picture generating unit 20 is already explained in detail by referring to FIG. 2.

The codec 83 converts signals transferred from the wireless transceiver 81 according to control of the CPU 82 and outputs the converted signal to the audio output device 85. The codec 83 also converts audio data inputted from the audio input unit 88 to an audio signal and transfers the audio signal to the CPU and the audio signal is outputted through the wireless transceiver 81.

The storing unit 84 stores programs for driving the wireless communication terminal such as a code and a firmware. Specially, the storing unit 84 stores still images took by using the camera unit 89 and a moving picture generated by using the took still images.

The audio output unit 85 outputs the audio data transferred from the codec 83 and the audio input unit 88 transfers audio data inputted from a user to the codec 83.

The displayer (LCD) 86 provides a user interface to a user according to control of the CPU 82. The displayer 86 also displays a user interface for selecting still images and displays the moving picture produced by using the selected still images.

The input unit 87 receives inputs from a user, where the inputs includes telephone numbers and a menu selection signal including a photographing request signal, a editing request signal, a sill image selection signal.

The camera unit 89 takes a still image or a moving picture according to control of the CPU.

As mentioned above, the present invention can maximize the use of the wireless communication terminal with the camera unit by generating a moving picture by using a plurality of still images and generating a multimedia moving data by adding a background music to the generated moving picture.

The present application contains subject matter related to Korean patent application No. 2004-71855, filed in the Korean Intellectual Property Office on Sep. 8, 2004, the entire contents of which being incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A wireless communication terminal for producing a moving picture by using a plurality of still images, the wireless communication terminal comprising:
a controller for controlling the wireless communication terminal;
a camera module for obtaining still image according to a control of the controller;
a storage for storing the obtained still image according to a control of the controller and storing a moving picture generated by using the obtained still image;
an input unit for receiving a menu selection signal including an editing request signal and a still image selection signal;
a generator for generating a moving picture according to the editing request signal by selecting a plurality of still images according to the still image selection signal from the input unit, reading the selected still images from the storage and using the read still images, storing the generated moving picture, and reproducing the stored moving picture; and
a displayer for outputting the reproduced moving picture according to a control of the controller.

2. The wireless communication terminal as recited in the claim 1, wherein the generator includes:
a still image selector for reading a plurality of still images stored in the storage according to a still image selection signal externally inputted for generating a moving picture;
a moving picture generator for generating a moving picture file by using the read still images from the still image selector according to a predetermined moving picture format, and storing the generated moving picture file to the storage; and
a moving picture reproducer for reading the moving picture file generated in the moving picture generator from the storage, reproducing the read moving picture file and outputting the reproduced moving picture file through the displayer.

3. The wireless communication terminal as recited in the claim 2, further comprising: a background music insertion unit for selecting one music source files stored in the storage according to a background music selection signal externally inputted, reading the selected music source file from the storage, transferring the read music source file to the moving picture generation unit, and generating the moving picture file by mixing the transferred music source file with the plurality of still images according to the predetermined moving picture format at the moving picture generation unit.

4. The wireless communication terminal as recited in claim 3, wherein the music source file is an advanced audio coding (AAC) format.

5. The wireless communication terminal as recited in claim 3, wherein the music source file is a qualcomm code excited linear prediction (QCELP) format.

6. The wireless communication terminal as recited in claim 3, wherein the music source file is an enhanced variable rate coder (EVRC) format.

7. The wireless communication terminal as recited in claim 3, further comprising: an effect processing unit for processing a predetermined effect on the still images read by the still image selector according to an effect request signal, wherein the predetermined effect includes a filtering effect, a drawing, an insertion of text, a stamping, a insertion of frame and an insertion of effect sound.

8. The wireless communication terminal as recited in claim 7, wherein the predetermined moving picture format is a moving picture experts group (MPEG)-4.

9. The wireless communication terminal as recited in claim 8, wherein the moving picture generator generates I frames of each still image read by the still image selector, generates a MPEG-4 video image having the generated I frame within a predetermined interval, and stores the generated MPEG-4 video image in the storage.

10. The wireless communication terminal as recited in claim 8, wherein the moving picture generator generates I frames of each still image read by the still image selector, arranges I frame within a predetermined interval, generates P frame by combining information of a previous I frame and a next I frame in a predetermined rate, generates a MPEG-4 video image by arranging generated P frame between the I frames, and stores the generated MPEG-4 video image in the storage.

11. The wireless communication terminal as recited in claim 10, wherein the moving picture generator controls a time for displaying each still image by repeatedly storing the I frame.

12. A wireless communication terminal for producing a moving picture by using a plurality of still images, the wireless communication terminal comprising:
a controller for controlling the wireless communication terminal;
a camera module for obtaining still image according to a control of the controller;
a storage for storing the obtained still image according to a control of the controller and storing a moving picture generated by using the obtained still image;
an input unit for receiving a menu selection signal including an editing request signal and a still image selection signal; and
a displayer for outputting the reproduced moving picture according to a control of the controller.

13. The wireless communication terminal as recited in claim 12, wherein the controller includes:
a generator for generating a moving picture according to the editing request signal by selecting a plurality of still images according to the still image selection signal from the input unit, reading the selected still images from the storage and using the read still images, storing the generated moving picture, and reproducing the stored moving picture.

14. The wireless communication terminal as recited in claim 13, wherein the controller includes:
a still image selector for reading a plurality of still images stored in the storage according to a still image selection signal externally inputted for generating a moving picture;
a moving picture generator for generating a moving picture file by using the read still images from the still image selector according to a predetermined moving picture format, and storing the generated moving picture file to the storage; and
a moving picture reproducer for reading the moving picture file generated in the moving picture generator from the storage, reproducing the read moving picture file and outputting the reproduced moving picture file through the displayer.

15. The wireless communication terminal as recited in claim 14, wherein the controller further includes: background music insertion unit for selecting one music source files stored in the storage according to a background music selection signal externally inputted, reading the selected music source file from the storage, transferring the read music source file to the moving picture generation unit, and generating the moving picture file by mixing the transferred music source file with the plurality of still images according to the predetermined moving picture format at the moving picture generation unit.

16. The wireless communication terminal as recited in claim 15, wherein the controller further includes: effect process unit for processing a predetermined effect on the still images read by the still image selector according to an effect request signal, wherein the predetermined effect includes a filtering effect, a drawing, an insertion of text, a stamping, a insertion of frame and an insertion of effect sound.

17. The wireless communication terminal as recited in claim 16, wherein the predetermined moving picture format is a moving picture experts group (MPEG)-4.

18. The wireless communication terminal as recited in claim 17, wherein the moving picture generator generates I frames of each still image read by the still image selector, generates a MPEG-4 video image having the generated I frame within a predetermined interval, and stores the generated MPEG-4 video image in the storage.

19. The wireless communication terminal as recited in claim 17, wherein the moving picture generator generates I frames of each still image read by the still image selector, arranges I frame within a predetermined interval, generates P frame by combining information of a previous I frame and a next I frame in a predetermined rate, generates a MPEG-4 video image by arranging generated P frame between the I frames, and stores the generated MPEG-4 video image in the storage.

20. The wireless communication terminal as recited in claim 19, wherein the moving picture generator controls a time for displaying each still image by repeatedly storing the I frame.

21. A method for producing a moving picture by using still images, the method comprising the steps of:
a) selecting a plurality of still image for producing the moving picture;
b) generating a moving picture file according to a predetermined moving picture format by using the selected still images; and
c) storing the generated moving picture file.

22. The method as recited in claim 21, further comprising the step of: d) processing the selected still images to give a predetermined effect on the selected still image.

23. The method as recited in claim 21, wherein the step b) includes the steps of:
b-1) generating a video file by using the selected still images;
b-2) selecting a music source file for a background music;
b-3) generating a moving picture file by mixing the selected still imaged and the selected music source; and
b-4) storing the generated moving picture file.

24. The method as recited in claim 23, wherein in the step b-1), I frames of each still image read by the still image selection means are generated and a MPEG-4 video image having the generated I frame within a predetermined interval is generated.

25. The method as recited in claim 23, wherein the step b-1), I frames of each still image read by the still image selection means are generated, I frames within a predetermined interval are arranged, P frame is generated by combining information of a previous I frame and a next I frame in a predetermined rate, and a MPEG-4 video image is generated by arranging generated P frame between the I frames.
